(19) United States
(12) Patent Application Publication
(10) Pub. No.: US 2008/0088136 A1
(43) Pub. Date: Apr. 17, 2008

(54) Portable generator

(76) Inventors: Yunfeng Ma, Suzhou (CN); Shizhou Wu, Suzhou (CN)

Correspondence Address: OLIFF & BERRIDGE, PLC, P.O. BOX 320850, ALEXANDRIA, VA, 22320-4850, US

(21) Appl. No.: 11/651,550

(22) Filed: Jan. 10, 2007

(30) Foreign Application Priority Data
Oct. 17, 2006 (CN) 200610096909.7

(51) Int. Cl. F02B 63/04

(52) U.S. Cl. 290/1 R

(57) ABSTRACT

The invention discloses a portable generator comprising a case provided with a handle, and a generator set located in the case; a link span is affixed to the bottom of said case, the generator set is affixed to the link span through a cushion block, and a mounting arm extends upward on the top of the generator set, and is embedded in the top of the case through a cushion sleeve; the generator set of the invention is mounted in the case through the cushion block and the cushion sleeve, which is not only good in the cushion effect but also light in weight and convenient to mounting and maintaining.

### FIELD OF THE INVENTION

The invention relates to a portable generator.

### BACKGROUND OF THE INVENTION

A prior art portable generator comprises a generator set composed of an engine and a generator; the generator set is located in a case with a handle, so that the generator can be taken from one place to another.

Because the case will hold the total weight of the generator set in the case when a user delivers the generator by holding the handle, it is necessary for the case to be strong enough; it brings more challenges to a designer to increase strength of the case while not increase weight of the case, and also consider the sound-insulation effect.

A generator set of a current commercially available portable generator is mounted in a case basically in two kinds of structures:

One is that two half covers are affixed to the left and right of the exterior of the generator set, respectively, with the upper parts of the two half covers affixed to the top of the case and the lower parts to the bottom of the case through a link span, which will benefit not only cooling and ventilation of the crankcase and the air cooled cylinder of the engine but also sound insulation.

The other is that the generator set is mounted in the case through a bearing bracket.

Though the two structures above are good in the sound-insulation effect, the cooling effect and the whole rigidity, the cushion effect is not so ideal.

### SUMMARY OF THE INVENTION

The purpose of the invention is to provide a portable generator, where the generator set is mounted in a case through a cushion block and a cushion sleeve, which is not only good in the cushion effect but also light in weight and convenient to mounting and maintaining.

The technical solution of the invention is a portable generator, comprising a case provided with a handle, and a generator set located in the case; a link span is affixed to the bottom of said case, the generator set is affixed to the link span through a cushion block, and a mounting arm extends upward on the top of the generator set, and is embedded in the top of the case through a cushion sleeve.

The further technical solution of the invention is a portable generator, comprising a case provided with a handle, and a generator set located in the case; a link span is affixed to the bottom of said case, the generator set is affixed to the link span through a cushion block, and a mounting arm extends upward on the top of the generator set, and is embedded in the top of the case through a cushion sleeve; said cushion block is connected to the generator set through an upper bolt extending upward, and provided with a lower bolt extending downward that is affixed to the link span through a nut; the lower part of said cushion block is embedded in a corresponding recess in the link span.

The more detailed technical solution of the invention is a portable generator, comprising a case provided with a handle, and a generator set located in the case; a link span is affixed to the bottom of said case, the generator set is affixed to the link span through a cushion block, and a mounting arm extends upward on the top of the generator set, and is embedded in the top of the case through a cushion sleeve; said cushion block is connected to the generator set through an upper bolt extending upward, and provided with a lower bolt extending downward that is affixed to the link span through a nut; the lower part of said cushion block is embedded in a corresponding recess in the link span; said cushion sleeve covering the mounting arm is embedded upward in a groove in the top of the case; said mounting arm is located on a cylinder head cover on the top of the generator set, the mounting arm is provided with a barbed convex block on either side of its head, the cushion sleeve is provided with a slot in its bottom surface, and the head of the mounting arm is inserted into the slot.

The advantages of the invention are as follows:

1. The generator set of the invention is affixed to the link span and the case through the cushion block and the cushion sleeve, which is not only good in the cushion effect, but also prolongs service life of the generator.

2. The portable generator of the invention is simple in structure, and convenient to disassembly, assembly and maintaining.

3. The invention removes the left and right covers, which benefits heat dissipation of the generator set, and reduces the whole weight.

The invention will be further described in combination with drawings and embodiments in the following.

### BRIEF DESCRIPTION OF THE DRAWINGS

FIG. 1 is a schematic drawing of the structure of the invention.

FIG. 2 is a schematic drawing of the structure of the generator set.

FIG. 3 is a schematic drawing of the structure of the link span.

FIG. 4 is a schematic drawing of the structure of the cylinder head cover.

FIG. 5 is a schematic drawing of the structure of the cushion sleeve.

Where: 1. case; 2. generator set; 3. link span; 4. cushion block; 5. mounting arm; 6. cushion sleeve; 7. upper bolt; 8. lower bolt; 9. nut; 10. recess; 11. groove; 12. cylinder head cover; 13. barbed convex block; 14. slot; 15. handle.

### DETAILED DESCRIPTION OF THE EMBODIMENTS

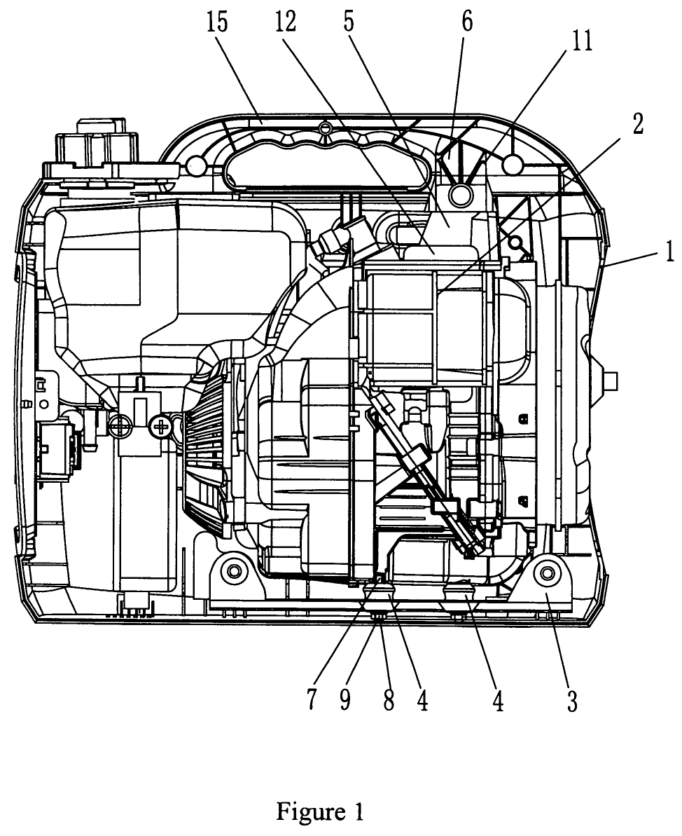

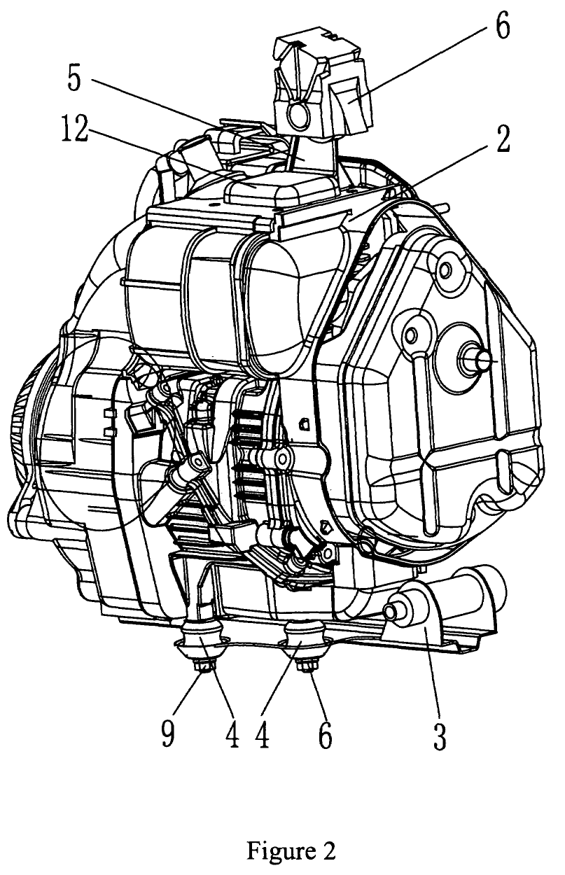

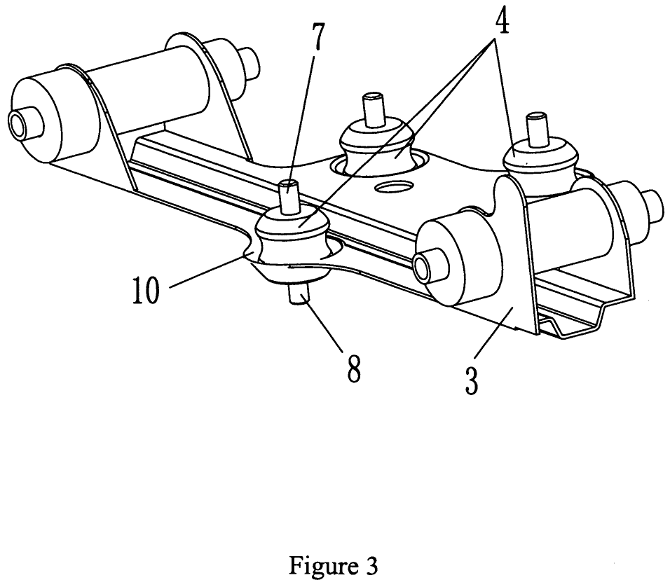

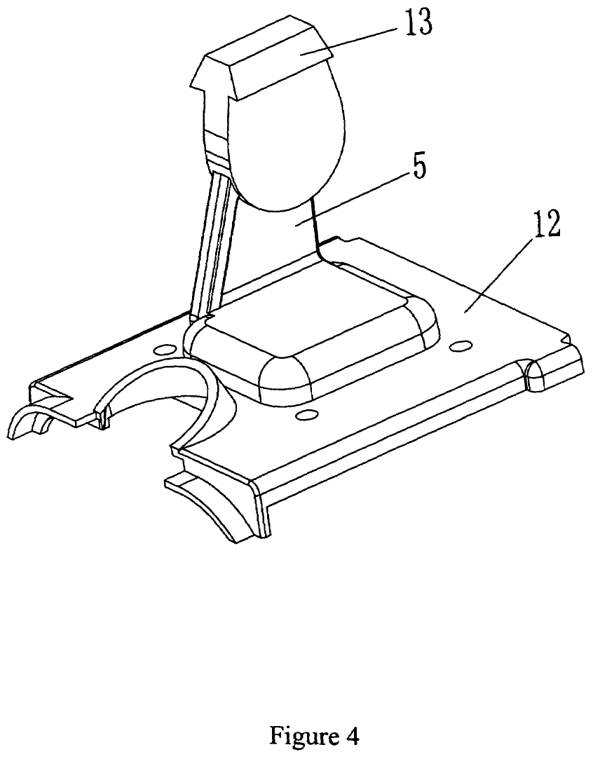

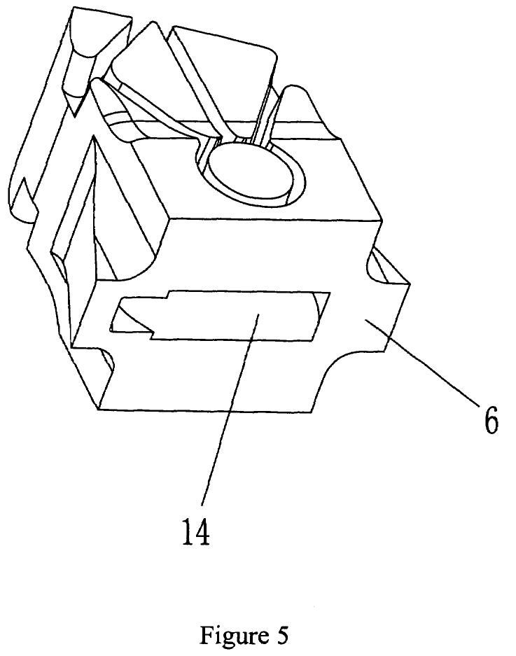

An embodiment: As shown in FIG. 1, FIG. 2, FIG. 3, FIG. 4, and FIG. 5, a portable generator, comprising a case 1 provided with a handle 15, and a generator set 2 located in the case 1; a link span 3 is affixed to the bottom of said case 1, and the case 1 is provided with a groove 11 in its top;

An mounting arm 5 extends upward on a cylinder head cover 12 on the top of the generator set 2, the head of the mounting arm 5 is covered by a cushion sleeve 6 and embedded in a groove 11 on the top of the case 1, the mounting arm 5 is provided with a barbed convex block 13 on either side of its head, the cushion sleeve 6 is provided with a slot 14 in its bottom surface, and the head of the mounting arm 5 is inserted into the slot 14.

The generator set 2 is affixed to the link span 3 through a cushion block 4; the cushion block 4 is connected to the generator set 2 through an upper bolt 7 extending upward, and provided with a lower bolt 8 extending downward that is affixed to the link span 3 through a nut 9; the lower part of the cushion block 4 is embedded in a corresponding recess 10 in the link span 3.

The generator set 2 of the invention is affixed to the link span 3 and the case 1 through the cushion block 4 and the cushion sleeve 6, which is not only good in the cushion effect, but also prolongs service life of the generator; the portable generator of the invention is simple in structure, and convenient to disassembly, assembly and maintaining; the invention removes the left and right covers, which benefits heat dissipation of the generator set 2, and reduces the whole weight.

1. A portable generator, comprising: a case provided with a handle, and a generator set located in the case; the portable generator wherein a link span is affixed to the bottom of said case, the generator set is affixed to the link span through a cushion block, and a mounting arm extends upward on the top of the generator set, and is embedded in the top of the case through a cushion sleeve.

2. The portable generator according to claim 1, wherein said cushion block is connected to the generator set through an upper bolt extending upward, and provided with a lower bolt extending downward that is affixed to the link span through a nut.

3. The portable generator according to claim 2, wherein the lower part of said cushion block is embedded in a corresponding recess in the link span.

4. The portable generator according to claim 1, wherein said cushion sleeve covering the mounting arm is embedded upward in a groove in the top of the case.

5. The portable generator according to claim 4, wherein said mounting arm is located on a cylinder head cover on the top of the generator set, the mounting arm is provided with a barbed convex block on either side of its head, the cushion sleeve is provided with a slot in its bottom surface, and the head of the mounting arm is inserted into the slot.
